(19) United States
(12) Patent Application Publication
(10) Pub. No.: US 2020/0305476 A1
(43) Pub. Date: Oct. 1, 2020

(54) PULSE BASED MEAT SUBSTITUTE

(71) Applicants: Mark H. Sterner, Riverside, CA (US); Mark M. Sterner, Sutherlin, OR (US)

(72) Inventors: Mark H. Sterner, Riverside, CA (US); Mark M. Sterner, Sutherlin, OR (US)

(21) Appl. No.: 16/902,977

(22) Filed: Jun. 16, 2020

Related U.S. Application Data
(63) Continuation-in-part of application No. 15/341,803, filed on Nov. 2, 2016.

(51) Int. Cl. A23L 11/00; A23L 5/00; A23L 5/10; A23L 5/30; A23P 30/20; A23P 10/25; A23L 27/26

(52) U.S. Cl. CPC A23L 11/05; A23L 5/55; A23L 5/13; A23V 2002/00; A23P 30/20; A23P 10/25; A23L 27/26; A23L 5/30

(57) ABSTRACT

A method is disclosed for forming a substantially homogenously colored dehydrated flaked pulse food product which may be simulative of the size, color, texture, and consistency of a dried, crumbled meat product that overcomes several deficiencies associated with textured vegetable protein based simulative meat products. The dehydrated flaked pulse food product is suitable for consumption without requiring further preparation. The method overcomes the requirement that an artificial food coloring be used to achieve a homogenous color, and if pulses other than soy are utilized, the product may be consumable by those with soy allergies and by those who object to the phytoestrogen and hexane content associated with conventional textured vegetable protein based meat analogues. Methods for forming related dehydrated flaked pulse food products are also contemplated which may not necessarily be simulative of any particular meat product.

### CROSS-REFERENCE TO RELATED APPLICATIONS

This is a continuation-in-part of U.S. Non-Provisional patent application Ser. No. 15/341,803 filed Nov. 2, 2016 and entitled PULSE BASED MEAT SUBSTITUTE SIMULATIVE OF THE APPEARANCE, TEXTURE, AND COLOR OF DRIED, CRUMBLED MEAT PRODUCTS, the entire disclosure of which is herein incorporated by reference.

### STATEMENT RE: FEDERALLY SPONSORED RESEARCH/DEVELOPMENT

Not Applicable

### BACKGROUND

### 1. Technical Field

The present disclosure relates generally to the field of legume-protein based meat analogues. More particularly, the present disclosure relates to the manufacture of a textured pulse protein meat analogue which may be simulative of certain aspects of dried, crumbled meat products, such as size, consistency, color, and texture.

### 2. Related Art

A strong market demand exists for vegetable-protein based meat analogues, especially among consumers having religious, ethical, environmental, health, or allergenic concerns regarding the consumption of meat products or certain subsets of meat products. Historically, the most popular vegetable-protein based meat analogues have been derived from soy protein or wheat gluten. One particular vegetable-protein based meat analogue product that has met wide acceptance in the marketplace is imitation crumbled bacon, also variously referred to as bits, pieces, or nibs, which are generally manufactured from textured vegetable protein that has been artificially flavored and colored to be simulative of crumbled dried bacon. Textured vegetable protein (TVP), also known as textured soy protein (TSP), is an established food ingredient that is generally manufactured via passing defatting soy flour containing a certain water content through a high-pressure continuous extruder-cooker to produce an expanded porous structure possessing chewy and elastic textural characteristics imitative of meat and is more fully described by U.S. Pat. No. 3,488,770. The use of TVP in the production of imitation bacon bits and other TVP-based meat analogues, however, suffers from certain deficiencies.

For example, commercially available TVP-based meat analogues require artificial coloring to achieve the simulative appearance of meat, with many shelf-stable TVP-based imitation meat analogues, including nearly all imitation bacon bits, including the artificial food die Red 40, an ingredient that in in past has been the subject of various controversies.

Most commercially available TVP-based imitation meat products also require extensive processing to achieve the simulative appearance, texture, and taste of the meat product that is being simulated while remaining shelf stable without requiring refrigeration. This processing may include the addition of certain artificial preservatives, artificial flavoring agents and hydrogenated or partially-hydrogenated oils which consumers and governmental or religious bodies may object to.

Furthermore, TVP utilizes soy as its core ingredient, which carries with it certain other deficiencies. Soy allergy is a common food allergy. Other consumers may object to the consumption of soy based upon the presence of phytoestrogens or hexane.

Furthermore, like any other commodity, the availability and price of soy and the soy-derived products used by manufacturers engaged in the production of TVP is subject to volatility, which may make alternatives to TVP which do not use soy preferable.

In certain cases, some manufacturers of vegetable-protein based meat analogous products have turned to combinations of different vegetable, including legumes such as peas in an effort to avoid the use of TVP due to the presence of soy. For example, certain meat simulant products now available on the market utilize a combination of pea protein isolate, rice protein, and mung bean protein as their protein source. However, these products may also suffer from certain of the above-discussed deficiencies and others, including the potential to unknowingly expose end-consumers to allergens due to the use of a wide variety of combined sources of vegetable proteins, rather than a single source.

Therefore, novel pulse-protein based meat analogues are desirable.

### BRIEF SUMMARY

To solve these and other problems, a method of forming a homogenously-colored dehydrated flaked pulse-based food product from a quantity of raw, dried pulses is contemplated. According to one exemplary embodiment, a dehydrated flaked pulse-based food product is formed from lentils and achieves a homogenous color without requiring the addition of artificial coloring. According to one particular exemplary embodiment, the dehydrated flaked pulse-based food product is formed from pinto beans and achieves a homogenous reddish-brown color without requiring the addition of artificial coloring, and is otherwise sized, textured, and flavored to be simulative in all respects of dried, crumbled bacon. In other embodiments, however, it is contemplated that other pulses may be alternatively or additionally utilized, such as red beans or yellow or green peas, and that other flavorings and/or homogenous colors may be achieved, such as flavors and colors simulative of the appearance of pepperoni, chorizo, and honey ham, or other flavorings or appearances which may not necessarily seek to simulate a meat product, such as flavorings and appearances based upon cinnamon, vanilla, dates, or turmeric, among many other potential variations.

The method of forming the homogenously-colored dehydrated flaked pulse-based food product may, according to one methodology, comprise the steps of providing a quantity of uncooked, dried pulses, hydrating the uncooked, dried pulses to a water content of from about 30% to about 70%, cooking the hydrated pulses in a steam environment, flaking the pulses via preferably passing the cooked pulses through three consecutive discrete pairs of cooperating rollers, wherein the rollers of the first discrete pair have respective substantially identical diameters greater than the respective diameters of the second and third discrete pairs, have a nip region greater than respective nip regions of the second and third discrete pairs, have substantially the same rotational speed in relation to one another and in opposing rotational directions to each other, and are operative to form and deliver a crushed pulse product, the rollers of the second discrete pair have a nip region sufficient to maintain above the nip region a rolling bead of crushed pulse product passed from the first pair of rollers, have substantially the same surface speed in relation to one another and in opposing rotational directions to each other, and are operative to convert the crushed pulse product into a ribbon of crushed pulse dough, and the rollers of the third discrete pair have a nip region sufficient to accept the ribbon of crushed pulse dough passed from the second pair of rollers, have substantially the same surface speed in relation to one another and in opposing rotational directions to each other, have a faster surface speed than the surface speed of the second pair of rollers, and are operative to convert the ribbon of crushed pulse dough into a flaked pulse food product, dehydrating the flaked pulse food product; and breaking up the dehydrated flaked pulse food product to produce a dehydrated flaked pulse food product of a desired size, wherein during the cooking the pulses, the cooking time, cooking pressure, cooking temperature, and water content of the hydrated pulses are controlled such that the dehydrated flaked pulse food product is substantially homogenous in color.

Alternatively, according to another methodology, the step of flaking the pulses may be performed via introducing the cooked pulses into a mixer grinder to form a deliver a crushed pulse food product, introducing the crushed pulse food product into a forming extruder to form and deliver a crushed pulse dough, and passing the crushed pulse dough through a pair of cooperating rollers, wherein the rollers have substantially the same surface speed in relation to one another and in opposing rotational directions to each other, and are operative to convert the crushed pulse dough into a flaked pulse food product.

In various refinements of the methodologies, the uncooked, dried pulses may be hydrated to a water content of from about 45% to about 65% during the hydration step, and the pulses are dehydrated to a water content of from about 2% to about 10% during the dehydration step.

One or more flavoring ingredients may be added at various stages of the methodologies in order to add flavors to the dehydrated flaked pulse food product. It may be desirable to add the flavoring ingredients prior to the cooking step, after the dehydrated flaked pulse food product is formed, or at other times, or to add various flavoring ingredients at different times.

In the exemplary embodiment, the step of adding the flavoring ingredients causes the dehydrated flaked pulse food product to have a flavor simulative of bacon. However, in other embodiments, the step of adding the flavoring ingredient may cause the dehydrated flaked pulse food product to have a flavor simulative of pepperoni, chorizo, or honey ham.

In one exemplary embodiment of the method utilizing the three discrete cooperating pairs of rollers for flaking the cooked pulses, the rollers of the first discrete pair have a diameter of about 20 inches, a nip region of about 0.048 inches, and a rotational speed of about 22 Hz, the rollers of the second discrete pair have a diameter of about 12 inches, a nip region of about 0.004 inches, and a rotational speed of about 10 Hz, and the rollers of the third discrete pair have a diameter of about 12 inches, a nip region of about 0.004 inches, and rotational speed of about 38 Hz.

In the exemplary embodiment of the method utilizing the mixer grinder, forming extruder, and single pair of cooperating rollers for flaking the pulses, the rollers have a diameter of about 12 inches and a nip region of about 0.004 inches.

According to the exemplary embodiment, the desired size to break up the dehydrated flaked pulse food product may be a diameter of ⅜ inch or less measured at their widest point for a majority of the broken-up flakes.

In the exemplary embodiment, the pulses utilized are exclusively lentils. However, in other embodiments, it may be seen that the pulses may be exclusively or a mix of one or more of the following: lentils, pinto beans, red beans, yellow peas, or any other pulse or pulses known to be useful for culinary or nutritional purposes.

According to another exemplary embodiment of the methodology, to achieve a homogenous color simulative of dried crumbled bacon when pinto beans are used, the pinto beans may be cooked for about 31 minutes in a steam environment controlled to about 252° F., to about 7.0 pH, and to about 17 psi.

### BRIEF DESCRIPTION OF THE DRAWINGS

These and other features and advantages of the various embodiments disclosed herein are better understood with respect to the following descriptions and drawings, in which:

FIG. 1 is a flowchart illustrating the sequence of operations performed in the practice of an exemplary embodiment of the method of forming a homogenously-colored dehydrated flaked pulse food product;

FIG. 2 is a front elevational view of a rotary steam cooker which may be used in the practice of the method of forming a homogenously-colored dehydrated flaked pulse food product;

FIG. 3 is a partial cross-sectional view of a continuous screw steam cooker which may be used in the practice of the steam cooking step of the method of forming a homogenously-colored dehydrated flaked pulse food product;

FIG. 4 is a cut-away perspective view illustrating the performance of the flaking step according to one embodiment of the steam cooking step of the method of forming a homogenously-colored dehydrated flaked pulse food product;

FIG. 5 is a side elevational view of sectional portion of FIG. 4;

FIG. 6 is a side elevational view illustrating performance of a portion of the flaking step according to another embodiment of the method of forming a homogenously-colored dehydrated flaked pulse food product; and

FIG. 7 is a cut-away side elevational view of a rotary sieve which may be used in the practice of the sizing step of the method of forming a homogenously-colored dehydrated flaked pulse food product.

Common reference numerals are used throughout the drawings and the detailed description to indicate the same elements.

### DETAILED DESCRIPTION

According to various aspects of the present disclosure, methods are disclosed for forming a homogenously colored dehydrated flaked pulse food product, with the exemplary embodiment of the method forming a dehydrated pulse food product from pinto beans, great northern and/or navy beans bearing a homogenous color simulative of dried, crumbled bacon, without requiring the addition of dedicated coloring ingredients.

In the following disclosure and the figures associated with it, an exemplary embodiment of a method is primarily discussed and referenced, with this exemplary embodiment exclusively utilizing lentils, peas, or pinto, great northern and/or navy beans to form to form a homogenously colored dehydrated flaked pinto pulse product. However, in interpreting the following disclosure, it should be recognized that the disclosure's scope is not merely limited to the use of lentils, pinto beans or any other specific pulses alone, but rather the disclosure and the specifics recited therein are broadly applicable to all pulses, which are the grain seeds of legumes, unless if it is specifically noted that a specific portion of the disclosure is exclusively applicable to only one type of pulse. Thus, unless specifically and prominently noted at the point where it is referenced, the recitation of a “pulse” in general or any one singular type of pulse or particular variety of an individual pulse, such as a lentil or pinto bean or a specific variety of a lentil or pinto bean and/or great northern and/or navy bean, is not intended to merely be limited to one type of pulse or a specific variety of one type of pulse, but rather the recitation of a “pulse” or any singular pulse or a variety of a pulse is to be broadly interpreted in the lexicographical sense as reciting any and all pulses and varieties of an individual pulse, or combinations of thereof, including but not limited to, for example, lentils, pinto beans, red beans, and yellow peas.

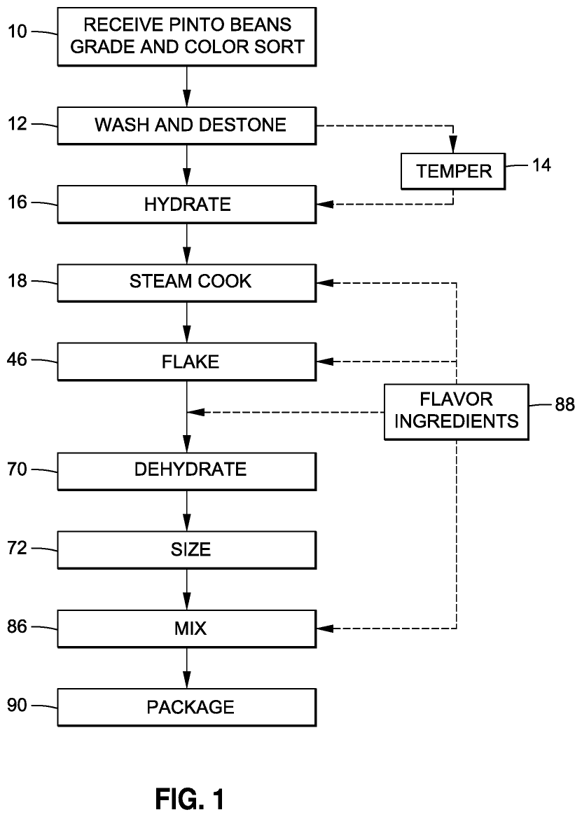

An exemplary embodiment of the method of forming the homogenously colored dehydrated pulse food product is generally illustrated in FIG. 1, which depicts a flowchart of the preferred sequences of operations performed.

According to the exemplary embodiment of the presently disclosed method, an inspection step 10 occurs wherein the pulses are received, graded, and color sorted into distinct groups that may be consumed together in the remaining steps of the method as a single batch, with entirely undesirable lentils or pinto beans being discarded. As it is an objective of the present disclosure that the resulting dehydrated flaked pulse food product produced have a homogenous color without requiring the addition of artificial coloring agents, it is preferable that the each batch of pulses are used in the subsequent steps of the exemplary embodiment of the method be generally similar in size, color, and consistency prior to the performance of the subsequent steps of that method. This is because it is also an objective of the present disclosure that the final resulting dehydrated flaked pulse food product be generally homogenous in color and consistency across batches of pulses which may initially have slight variations in color, size, and consistency. Because these starting characteristics of each graded and sorted batch of pulses may vary, and because it is desirable for the final product to be uniform regardless of these starting characteristics, the grading and sorting is important so that the parameters of the subsequent steps of the method to be adjusted to compensate for the initial differences among the graded and sorted batches. The inspection step 10 may be carried out manually or automatically, and in in accordance with known or future developed methods, so long as the objective of grading and color sorting the pulses in the above described batches is achieved. Furthermore, it may be seen that in certain other embodiments of the presently disclosed methodologies, in order to produce a pulse based meat substitute having certain attributes, it may be preferable to utilize combinations of different types of pulses and/or individual varieties among those different types of pulses according to certain determined ratios, and as such, the inspection step may further include the formulation of these combinations of pulses and/or individual varieties among those different types of pulses according to such determined ratios. According to the exemplary embodiment of the presently disclosed methods, the pulse comprises a whole lentil. Such whole lentils may, for example but without limitation, be selected from the group consisting of French green lentils, petite Estoria lentils, Spanish Pardina lentils, marrow lentils, petite Castillo lentils, lenticche Verdi lentils, black beluga lentils, Richlea lentils, Red Chief lentils, Brewer lentils, Crimson lentils, Large Green lentils, Eston lentils, and Puy lentils. In an embodiment, whole lentils are selected from the group consisting of Brewer, Cedar, Crimson, Essex, Eston, French Green, Greenland, Impact, Merrit, Meteor, Morena, Pardina, Pennell, Redberry, Richlea, Rivland, Shasta, Vantage, and combinations thereof. In an embodiment, the whole lentil is the Madeline variety of the French Green lentil. In one particular preferred embodiment, the whole lentil may be a Canadian marble variety of lentil. While whole lentils are described further herein, it will be understood that the method may also encompasses other legumes. For example, according to another exemplary embodiment of the presently disclosed methods, whole pinto beans of the variety “AAC Island” were used. However, it may be seen that any pulse may be used according to the methods herein disclosed, and as such the recitation of the pulses herein need not be confined to whole or partial lentils, whole or partial pinto beans, and any varieties thereof, but may also include other varieties of P. vulgaris, including but not limited to the varieties generally known as kidney beans, navy beans, cranberry beans, appaloosa beans, and yellow beans, as well as other pulses, whether provided in whole form or in part.

According to the exemplary embodiment of the presently disclosed method, a washing and destoning step 12 may occur subsequently to the inspection step 10. However, it may be seen that the step of washing and destoning may also occur prior to grading and color sorting, or interspersed in various orders, without departing from the scope and spirit of the present disclosure, as the steps of washing and destoning does not substantially affect the characteristics of the pulses beyond aiding in removing foreign material, such as dirt, pesticides, stones, twigs, leaves, or other material which may be included among the pulses but may adversely affect or damage the quality or the production capacity of the dehydrated flaked pulse food product. The washing and destoning step 12 is generally performed by washing the pulses with water or another acceptable liquid capable of removing foreign material, and by manually or automatically removing the material. The washing and destoning step 12 may be carried out manually or automatically, and in accordance with known or future developed methods, so long as the objective of removing the above described foreign material is removed.

According to an optional embodiment of the presently disclosed method, a tempering step 14 may occur following the inspection step 10 and the washing and destoning step 12, wherein the pulses are immersed in water for a period of time so that they may absorb water thereinto, and subsequently thereafter the water is drained and the pulses are permitted to stand to permit the absorbed water to equilibrate throughout. As those skilled in the art will recognize, the amount of time the pulses are immersed and permitted to stand during the optional tempering step 14 may vary according to the characters of the specific batch being tempered.

According to the exemplary embodiment of the presently disclosed method, a hydration step 16 may occur subsequent to the previously described steps. In the exemplary embodiment, this step comprises the hydration of lentils or pinto beans, peas and/or great northern and/or navy beans to a water content of from about 30% to about 70%. According to a more preferred embodiment of the exemplary embodiment, this hydration step comprises the hydration of the lentils or the pinto beans to a water content of from about 45% to about 65%. The hydration step 16 may, in certain embodiments, be an independent step distinct from the tempering step 14 and the steam cooking step 18. However, it other embodiments, it may be seen that the hydration step may be performed in lieu of a tempering step, 14 or may occur during the steam cooking step 18 via the moisture content from the steam itself. The hydration step 16 may be performed, for example, by soaking the pulses in water for a period of time sufficient to elevate the water content of the pulses to the desired level. However, it may be seen that known or future developed methods of hydrating pulses may be utilized without departing from the scope or spirit of the presently disclosed methods. In the exemplary embodiment, the hydrating step 16 occurs directly after the step of washing and destoning with no intervening tempering step 14, and during this step the lentils or pinto beans are hydrated to a 47% water content. It may thus be seen that the water content of the pulses prior to the steam cooking step 18 may material affect the final dehydrated flaked pulse food product, in that with all other conditions and variable in other steps being held steady, generally a higher water content will result in a lighter color, while a lower water content will result in a darker color.

According to an exemplary embodiment of the presently disclosed method, a steam cooking step 18 may occur following the hydration step 16. The steam cooking step 18 comprises cooking the pulses in a steam environment. According to a various embodiment of the steam cooking step 18, the time, pressure, temperature, moisture content, and pH at which the steam cooking step 18 occurs may be subject to variation to achieve a final dehydrated flaked pulse food product having a lighter or darker color. Specifically, by increasing the time, pressure, temperature, or pH of conditions under which the pulses are steam cooked, the resulting dehydrated flaked pulse food product produced is generally darker in color, and by decreasing those variables, the resulting dehydrated flaked pulse food product produced is lighter in color. Furthermore, an optimization of these variables, along with others in the process, may result in greater or less homogeneity among the color of the resulting dehydrated flaked pulse food product. For example, in the embodiment of the method for producing a pinto-bean based dried crumbled bacon product, it was found that cooking the 47% water content pinto beans in saturated steam at 252° F. and 17 PSI for 31 minutes resulting in dried flakes having a preferred reddish brown color that was homogenous throughout, and when rehydrated (40 g in 100 ml water), resulted in a spectrophotometer reading (Hunterlab Color Measurement Scale) of L=40.56, A=12.54, B-22.38. In comparison, in earlier experimental trials where all other variables were held steady except for the cooking time, less desirable results were achieved. With a cook time of 28 minutes, the resulting dehydrated flaked pulse food product produced from these pinto beans was somewhat less red in color, and did not display the desired color homogeneity, in that it was interspersed with darker colored skin particles. When the cooking time was increased to 30 minutes, the resulting color was more desirable (L=42.25, A=12.08, B=20.49), but the desired homogeneity was still not entirely present. It may thus be seen that by altering one or more of the above-described variables with an eye towards the initial batch of pulses received, a set of protocols may be achieved such that a desirable dehydrated flaked pulse food product may be produced having a desirable color that is substantially homogenous throughout. Further, it may be seen that, while in the exemplary embodiment the pinto beans are steam cooked at pressures higher than atmospheric, in other embodiments the step of cooking the pulses in a steam environment need not occur at pressures higher than atmospheric, but rather may occur at any pressure, including atmospheric pressure or pressures higher or lower than atmospheric pressure.

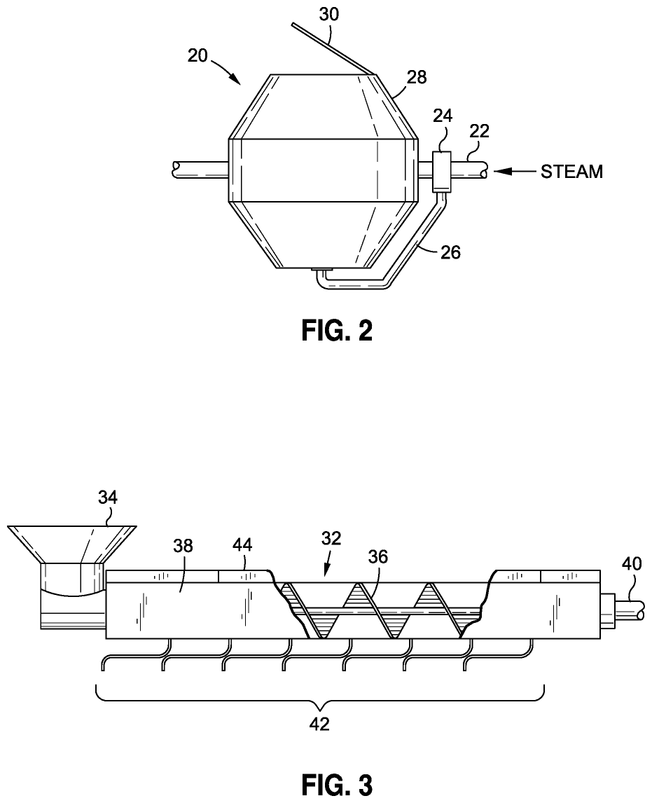

Turning now to FIG. 2, a rotary steam cooker 20 is shown, which may be one device with which the steam cooking step 18 may be performed. The rotary steam cooker 20 typically has a capacity of approximately fourteen cubic feet, and rotates the pulses contained therein to assure even and through cooking. Live steam is provided via an inlet line 22 from which it travels through a coupling 24 and a tube 26 into a housing 28. A lid 30 provides a means for placing the pulses into and removing the pulses from the rotating steam cooker 20. The steam cooker 20 is typically alternatively supplied with steam and then rotated. Injection of steam into the housing 28 when the rotary steam cooker 20 is in the upright position (with the lid 30 uppermost) insures even distribution of the steam throughout the pulses within the housing 38. Subsequent rotation of the rotary steam cooker 20 mixes the pulses to further insure uniform heat distribution.

Turning now to FIG. 3, a continuous steam cooker 32 is shown, which may be another device with which the steam cooking step 18 may be performed. The continuous steam cooker 32 is adapted to provide a steady output and is used by placing the pulses into the hopper 34 from which they are carried by a screw 36 through a housing 38 toward and outlet 40. Steam is supplied to the housing 38 through tubes 42 and contained therein by doors 44. The volumes of steam supplied by the tubes 42 may be varied along the length of the steam cooker 32, setting up zones of varying pressure, for example, lower pressure zones near the intake hopper 34 and the outlet 40. As those skilled in the art will also recognize, the continuous steam cooker 32 at the intake and outlet ends is preferably equipped with steam locks (not shown). Within the steam lock the pressure is equalized to the ambient room pressure or to the elevated cooking pressure before opening the respective steam lock door, to provide for a smooth flow of pulses entering and exiting the steam cooker 32. The doors 44 provide access to the interior of the housing 38 for cleaning and maintenance.

Returning now to FIG. 1, according to the exemplary embodiment of the presently disclosed method, a flaking step 46 may occur following the steam cooking step 18. During the exemplary embodiment of this flaking step 46, the cooked pulses are converted into flakes by the successive processes of crushing the cooking pulses, converting the crushed pulses into to a crushed pulse dough, and flattening and breaking apart the crushed pulse dough into a flaked pulse food product. Importantly, during the flaking step 46, the cooked pulses are converted into a flaked pulse product that is smooth (rather than gritty) and dries rapidly.

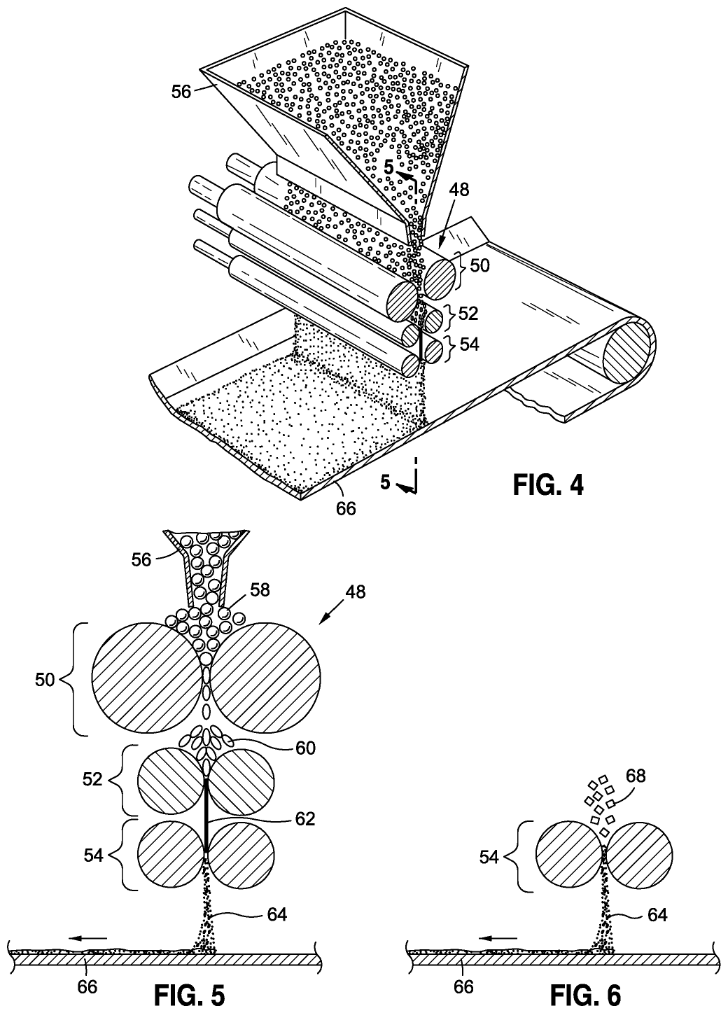

Turning now to FIG. 4, a sequential roller mill 48 is shown, which is a device with which the flaking step 46 may be performed. As may be seen in FIGS. 4 and 5, the sequential rolling mill 48 may comprises three discrete pairs of rollers, including a first pair of rollers 50, a second pair of rollers 52, and a third pair of rollers 54. The three roller pairs may be positioned in vertical alignment such that the first pair of rollers 50 is at the top, the second pair of rollers 52 is in the middle, and the third pair of rollers 54 is at the bottom, to enable the resulting product produced by each pair of rollers to pass via gravity directly into the next pair of rollers. However, it may also be seen that the rollers need not be directly vertically aligned, but rather any method of conveying the output from each roller pair to the next in sequence may be utilized. The first pair of rollers 50 may be fed by a roller mill hopper 56 such that the cooked pulses may be gravity-fed into the first pair of rollers 50 at a metered rate. Further, each roller may have a doctor blade (not shown) positioned across its face to remove product which may adhere to the roller. Each discrete pair of rollers is generally defined by its two rollers' diameters, which are generally substantially identical in relation to one another, by the rotational speed of the rollers, which are generally identical in relation to one another and in opposing rotational directions, and by their nip region, which is the distance between the rollers at their most proximal point. These variables may be seen to affect the outcome that occurs when a pulse intermediate product is passed though the discrete pair of rollers, serving both to affect the texture and fineness of the pulse product following passing through the rollers, and to provide a metering affect regulating the amount of pulse product flowing therethrough.

According to the exemplary embodiment, the flaking step 46 is performed via a sequential roller mill 48 having a first pair of rollers 50 with a diameter of about twenty inches, a nip region of about 0.048 inches, and a rotational speed of about 22 Hz, a second pair of rollers 52 with a diameter of about twelve inches, a nip region of about 0.004 inches, and a rotational speed of about 10 Hz, and a third pair of rollers 54 having a diameter of about twelve inches, a nip region of about 0.004 inches, and a rotational speed of about 38 Hz. However, it may be seen that these parameters may be altered to accommodate variances in the cooked pulses 58 input into the roller mill 48, without departing from the scope and spirit of the present disclosure, such as by altering the rotational speed or size of the nip regions of the discrete pairs of rollers. The first pair of rollers 50 serves to convert the cooked pulses 58 into a crushed pulse product 60. The second pair of rollers 52 serves to convert the crushed pulse product 60 into a ribbon of crushed pulse dough 62. The third pair of rollers serves to tear apart the ribbon of crushed pulse dough 62 and convert it into a flaked pulse food product 64. The flaked pulse food product may then be carried away on a conveyor 66. One important facet of a sequential roller mill 48 in such a configuration is that it may be preferred that these above described parameters be adjusted such that a rolling bead of crushed pulse product 60 is maintained above the nip region of the second pair of rollers 52. This is generally because a substantial portion of the homogenizing action of the sequential rollers occurs not directly from the compression in the nip region between two rollers, but by the frictional action of the successive pulse products being kinetically mixed against themselves above the nip region induced by the rotating action of the roller mills, with a continuous rolling bead of crushed pulse product 60 above the second pair of rollers being the most critical for creation of a flaked pulse food product 64 having a desirable consistency and homogeneity.

According to an alternative embodiment of performing the flaking step 46 however, it may be preferable to utilize alternate methods of delivering a crushed pulse product 60, delivering a crushed pulse dough 62, and delivering a flaked pulse food product 64. For example, a mixer grinder may be used to form and deliver a crushed pulse product 60. Furthermore, the crushed pulse product 60 may be formed into crushed pulse dough 62 via the use of a forming extruder. Such a forming extruder may be configured to form and deliver, for example, a continuous ribbon of crushed pulse dough 62, or may be configured to form and deliver a crushed pulse dough 62 in other forms, such as a pelletized crushed pulse dough 68. The production of a pelletized crushed pulse dough 68 may be preferred for various reasons, including for example, an ability to be stored for periods of time while frozen or refrigerated, or transported over distances, which may enable, for example, the production of the pelletized crushed pulse dough 68 at a high-capacity central location, with the performance of the subsequent steps at more dispersed locations, or may enable continuous production of a dehydrated flaked pulse food product year round even without a continuous supply of pulses.

Turning now to FIG. 6, another alternate embodiment is shown in which it may be seen that the pelletized pulse dough 68 may be converted to a flaked pulse food product 64 in a similar fashion to that of the exemplary embodiment, with the pelletized pulse dough 68 being passed through a pair of cooperating rollers having a configuration similar or identical to the above mentioned third pair of rollers 54. The process of producing the flaked pulse food product 64 may be generally similar or identically performed among the various embodiments, regardless of whether a ribbon of pulse dough 62 is fed into the third pair of rollers 54, as in the embodiment of FIGS. 4-5 or embodiments in which a former extruder produces a ribbon of pulse dough 62, or whether a pelletized pulse dough 68 is fed into the third pair of rollers 54, as in FIG. 6.

Returning now to FIG. 1, according to the exemplary embodiment of the presently disclosed method, a dehydrating step 70 may occur following the flaking step 46. One general objective of the dehydrating step may be to produce a dehydrated flaked pulse product having a consistency and texture simulative of a dried cooked meat product, with one exemplary embodiment producing a dehydrated flaked pinto bean product having a consistency and texture simulative of dried, crumbled bacon. However, it may also be seen that it may be desirable to produce a product that it not necessarily simulant of any particular existing meat product, but which rather may represent a new product not seeking to mimic any particular characteristics of an existing product. According to the exemplary embodiment, the flaked pulse food product 64 is passed on the conveyor 66 through a steam coil heated apron dryer to a water content of about 6.45±1%. However, it may be seen that in other embodiments, it may be preferable to produce a dehydrated flaked pulse food product having a higher or lower moisture content, for example, a moisture content of from about 2% to about 10%. Likewise, it may be seen that in other embodiments, other methods of dehydration may be utilized in addition to or as an alternative to an apron dryer, including for example, ovens, roasters, toasters, and dryers, the various use of which may provide similar or different color characteristics for the final flaked pulse food product 64. Regardless, it may be seen that the dehydrated step 70 may be carried out according to known or future developed methods of dehydrating without departing from the scope and spirit of the present disclosure, so long as the aim of dehydrating the flaked pulse food product 64 is achieved.

According to an exemplary embodiment of the presently disclosed method, a sizing step 72 may occur following the dehydrating step 70. The general objective of the sizing step is to further break up the dehydrated flaked pulse food product to a desired size. According to the exemplary embodiment, the sizing step results in the production of broken up dehydrated pulse flakes wherein the majority of the flakes have a diameter of ⅜ inch or less measured at their widest point. However, it may be seen that in other embodiments, a larger or smaller size of broken up pulse flakes may be preferable. Regardless, it may be seen that the sizing step 72 may be carried out according to known or future developed methods of reducing size without departing from the scope and spirit of the present disclosure, so long as the aim of breaking apart the dehydrated flaked pulse food product to a consistent size is achieved.

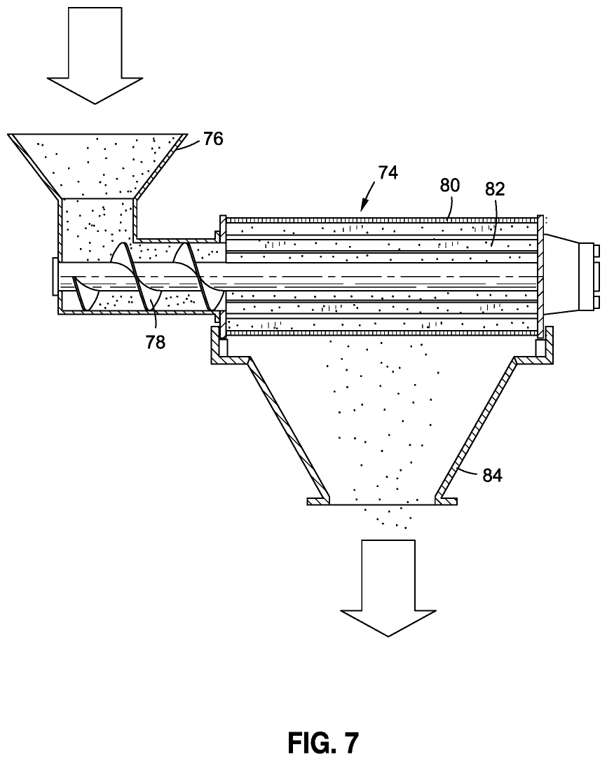

Turning now to FIG. 7, according to the exemplary embodiment, the sizing step 72 is performed via a rotary sieve 74 having a rotary sieve hopper 76, an auger 78, a drum sieve 80, and vanes 82. The dehydrated flaked pulse food product may be introduced into the rotary sieve hopper 76 and may be driven by the auger 78 into the drum sieve 80. The drum sieve 80 may have a plurality of apertures of a selected size, and may be contained in a housing (not shown). The vanes 82 may rotate to agitate the dehydrated flaked pulse food product and cause it to be driven against the drum sieve 80, whereupon it will be broken apart and pass through the apertures in the drum sieve 80. The resulting size of the broken up dehydrated pulse food product may depend upon the size of the apertures in the drum sieve 80, and may pass through the rotary sieve outlet 84. It also may be seen that the apertures in the drum sieve 80 may vary in size along the length of the drum sieve 80, and that the rotary sieve 74 may have multiple rotary sieve outlets 84 according to the variance in the size of the apertures, such that broken up dehydrated pulse food products being output from the each rotary sieve outlet 84 may have a distinct size corresponding to the different sizes of the apertures.

Returning now to FIG. 1, according to the exemplary embodiment of the presently disclosed method, a mixing step 86 may occur following the sizing step 72. According to the exemplary embodiment, the mixing step comprising the addition of one or more oils and a vitamin E, and one or more flavor ingredients 88. The oil may serve to improve the adherence of the flavor ingredients and to improve the texture and mouth-feel of the broken up dehydrated pulse food product, with the vitamin E, and specifically a tocopherol, which is known in the art to serve as a preservative for oils to prevent rancidity. However, it may be seen that in other embodiments, other ingredients, including but not limited to other adhering agents and/or preservatives may be added at the mixing step 86, or the step may be omitted entirely, especially if the flavor ingredients 88 are added at another stage of the method.

The flavor ingredients may be optionally added at one or more steps of the presently described method, including, for example, before, during, or after the steam cooking step 18, the flaking step 46, the sizing step 72, and the mixing step 86. In the exemplary embodiment where the desired flavor is simulative of dried, crumbled bacon, it may be preferable to use a flavor ingredient 88 such as salt to provide a salty taste sensation, a glutamic acid source such as a yeast extract to provide a savory/umami taste sensation, or a smoke distillate to provide a smoke flavor sensation. In an alternative embodiment wherein the desired flavor is simulative of chorizo, the it may preferable that the flavor ingredients 88 include chili pepper, paprika, cumin, garlic powder, salt, onion powder, citric acid, and red pepper. It should be readily appreciable, however, that the various flavor ingredients 88 that may be added and the permutations thereof are essentially infinite, and may be designed to be simulative of existing food products, or may even be designed to provide a unique taste sensation. For example, and without limitation, examples of flavors for which dehydrated flaked pulse food product may be configured to be simulative of include bacon, pepperoni, chorizo, or honey ham.

According to the exemplary embodiment of the presently disclosed method, a packaging step 90 may follow the mixing step 86. The packaging step may be carried out according to known or future developed methods of packaging food products, and as such is not limited to any specific method of packaging. For example, depending on certain aspects of the method herein disclosed and the method of packaging chosen, the resulting dehydrated flaked pulse food product may require refrigeration at all times, or only after the packaging is opened, or may be shelf-stable for a sufficient length of time to reach consumers and be consumed.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the exemplary embodiments.

What is claimed is:

1. A method of forming a meat substitute from a quantity of raw, dried pulses, the method comprising the steps of:
a) providing a quantity of uncooked, dried pulses;
b) hydrating the uncooked, dried pulses to water content of from about 30% to about 70%;
c) cooking the pulses in a steam environment;
d) flaking the cooked pulses;
e) dehydrating the flaked pulse food product; and
f) breaking up the dehydrated flaked pulse food product to produce a dehydrated flaked pulse food product of a desired size;
wherein during step c) of cooking the pulses, the cooking time, cooking pressure, cooking temperature, and pH of the steam environment, and the water content of the hydrated pulses, are controlled such that the dehydrated flaked pulse food product produced in step f) is substantially homogenous in color.

2. The method of claim 1, wherein step d) of flaking the cooked pulses comprises passing the cooking pulses through three consecutive discrete pairs of cooperating rollers, wherein:
i) the rollers of the first discrete pair have respective substantially identical diameters greater than the respective diameters of the second and third discrete pairs, have a nip region greater than respective nip regions of the second and third discrete pairs, have substantially the same rotational speed in relation to one another and in opposing rotational directions to each other, and are operative to form and deliver a crushed pulse product;
ii) the rollers of the second discrete pair have a nip region sufficient to maintain above the nip region a rolling bead of crushed pulses passed from the first pair of rollers, have substantially the same surface speed in relation to one another and in opposing rotational directions to each other, and are operative to convert the crushed pulse product into a ribbon of crushed pulse dough; and
iii) the rollers of the third discrete pair have a nip region sufficient to accept the ribbon of crushed pulse dough passed from the second pair of rollers, have substantially the same surface speed in relation to one another and in opposing rotational directions to each other, have a faster surface speed than the surface speed of the second pair of rollers, and are operative to convert the ribbon of crushed pulse dough into a flaked pulse food product.

3. The method of claim 1, wherein during step b), the uncooked, dried pulses are hydrated to a water content of from about 45% to about 65%.

4. The method of claim 1, wherein during step e), the flaked pulse product is dehydrated to a water content of from about 2% to about 10%.

5. The method of claim 1, further comprising the step of adding one or more flavoring ingredients such that the dehydrated flaked pulse food product produced in step f) has a flavor simulative of one of the following: bacon, pepperoni, chorizo, honey ham.

6. The method of claim 5, wherein the step of adding the one or more flavoring ingredients occurs prior to cooking the pulses in step c).

7. The method of claim 5, wherein the step of adding the one or more flavoring ingredients occurs after breaking up the dehydrated flaked pulse food product in step f).

8. The method of claim 2, wherein the rollers of the first discrete pair have a diameter of about 20 inches, a nip region of about 0.048 inches, and a rotational speed of about 22 Hz, the rollers of the second discrete pair have a diameter of about 12 inches, a nip region of about 0.004 inches, and a rotational speed of about 10 Hz, and the rollers of the third discrete pair have a diameter of about 12 inches, a nip region of about 0.004 inches, and a rotational speed of about 38 Hz.

9. The method of claim 1, wherein step e) of dehydrating the flaked pulse food product is accomplished via passing the flaked pulse food product through an apron dryer.

10. The method of claim 1, wherein in step f), the breaking up of the dehydrated flaked pulse food product results in the majority of the resulting sized dehydrated flaked pulse food product having a diameter of ⅜ inch or less measured at their widest point.

11. The method of claim 1, wherein the pulses are pinto beans and the dehydrated flaked food product has the appearance, texture, and color simulative of dried, crumbled bacon.

12. The method of claim 11, wherein during step c) of cooking the pinto beans, the steam environment is controlled to about 252° F., to about 7.0 pH, to about 17 psi, and the pinto beans are cooked for about 31 minutes.

13. The method of claim 1, wherein the pulses are one or more of the following: lentils, pinto beans, red beans, yellow peas, green peas.

14. The method of claim 1, wherein the step of flaking the cooked pulses comprises the steps of:
i. introducing the cooked pulses into a mixer grinder to form and deliver a crushed pulse product;
ii. introducing the crushed pulse product into a forming extruder to form and deliver a crushed pulse dough; and
iii. passing the crushed pulse dough through a pair of cooperating rollers, wherein the rollers have substantially the same surface speed in relation to one another and in opposing rotational directions to each other, and are operative to convert the crushed pulse dough into a flaked pulse food product.

15. The method of claim 14, wherein the rollers have a diameter of about 12 inches, a nip region of about 0.004 inches, and a rotational speed of about 38 Hz.

16. The method of claim 1, wherein the pulses are lentils.

17. The method of claim 1, wherein the pulses are navy beans.

18. The method of claim 1, wherein the pulses are peas.

19. The method of claim 1, wherein the pulses are great northern beans.
